(19) United States
(12) Patent Application Publication
(10) Pub. No.: US 2012/0048069 A1
(43) Pub. Date: Mar. 1, 2012

(54) TOOL FOR HAMMER UNIONS

(76) Inventor: Donald Powell, JR., Anchorage, AK (US)

(21) Appl. No.: 12/870,686

(22) Filed: Aug. 27, 2010

(51) Int. Cl. B25B 13/50

(52) U.S. Cl. 81/124.2

(57) ABSTRACT

A tool may eliminate over 90%, typically over 95% of the hammering needed to open or close a hammer union. Typically, to open or close a hammer union, a worker needs to swing a heavy hammer at a small tab on the hammer union. This conventional process may result in injury to the worker. The tool of the present invention may have a tool head designed to fit onto a hammer union. A handle of the tool, extending from the tool head, may be used to provide rotational torque to the hammer union.

### BACKGROUND OF THE INVENTION

The present invention relates to tools and, more particularly, to a tool for tightening and loosening hammer unions.

In the oil industry, there are mechanical fasteners used that are connected by hand and then pounded with a hammer to close. Such fasteners are typically referred to as hammer unions. Typically, users have to swing a heavy hammer, multiple times, to hit a small metal tab to tighten and/or loosen hammer unions. A worker may have to swing such a hammer upwards to 800 times per day. There is a serious potential for impact injuries when performing such an operation.

As can be seen, there is a need for a tool for tightening and loosening hammer unions that may require little if any impact work.

### SUMMARY OF THE INVENTION

In one aspect of the present invention, a tool comprises a tool head; a handle attached to and extending from the tool head; an opening in the tool head adapted to fit a pipe therethrough; at least one notch an inside surface of the tool head, the notch adapted to fit a tab of a pipe fitting, and the inside surface adapted to fit around at least a portion of the pipe fitting.

In another aspect of the present invention, a tool for opening or closing a hammer union, comprises a tool head having an opening, the opening adapted to permit a pipe having the hammer union disposed thereupon to fit into an inside of the tool head; a handle attached to and extending from the tool head; and two notches on the inside of the tool head, the notches adapted to align with tabs on the hammer union.

In a further aspect of the present invention, a method for opening or closing a hammer union comprises positioning a tool such than an inside opening of a tool head is around at least a portion of a pipe; sliding the tool along the pipe to the hammer union; positioning two tabs of the hammer union within two notches on the inside opening of the tool head; applying a force to a handle attached to the tool head, wherein the force applied to the handle applies torque to the hammer union.

These and other features, aspects and advantages of the present invention will become better understood with reference to the following drawings, description and claims.

### BRIEF DESCRIPTION OF THE DRAWINGS

FIG. 1 is a perspective view of a tool, according to an embodiment of the present invention, separated from a hammer union;

FIG. 2 is a top view of the tool of FIG. 1 attached to the hammer union;

FIG. 3 is a side view of the tool of FIG. 1 attached to the hammer union;

FIG. 4 is a side view, viewed from an open end of the tool of FIG. 1, showing the tool attached to the hammer union; and

FIG. 5 is a partial cross sectional view of the tool of FIG. 1 attached to the hammer union.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a tool that may eliminate over 90%, typically over 95% of the hammering needed to open or close a hammer union. Typically, to open or close a hammer union, a worker needs to swing a heavy hammer at a small tab on the hammer union. This conventional process may result in injury to the worker. The tool of the present invention may have a tool head designed to fit onto a hammer union. A handle of the tool, extending from the tool head, may be used to provide rotational torque to the hammer union.

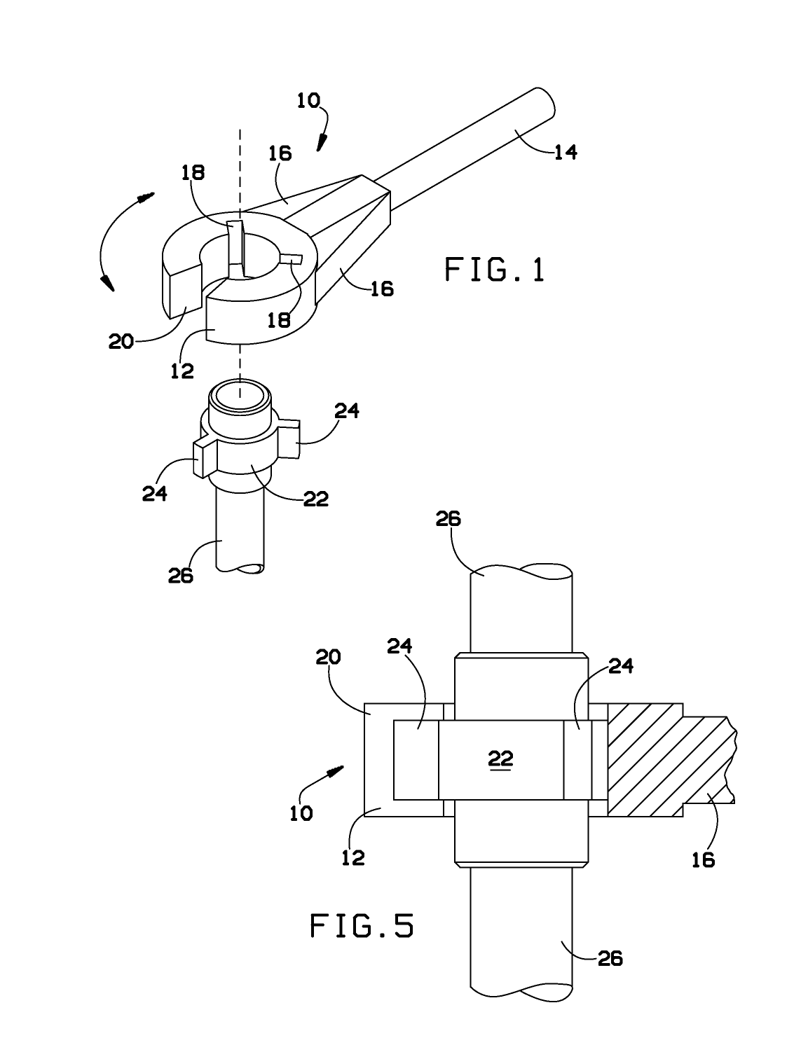

Referring to FIGS. 1 through 5, a tool 10 may include a tool head 12 having a handle 14 extending from the tool head 12. The tool head 12 may be circular in shape with an opening 20 in a portion of the tool head 12. Notches 18 may be cut into the interior surface of the tool head 12. Typically two notches 18, spaced apart by 120 degrees from each other and from the opening 20, are present in the tool head 12.

The opening 20 may be larger than the outside diameter of a pipe 26 that has a hammer union 22 attached thereupon. The tool head 12 may be positioned around the pipe 26 by slipping the pipe 26 through the opening 20. The tool head 12 may then be slid along the pipe 26 so that the tool head 12 is positioned on the hammer union 22, with the notches 18 of the tool head 12 receiving tabs 24 of the hammer union 22. Pulling or pushing on the handle 14 may exert a rotational torque to the hammer union 22. Unlike conventional methods of opening and closing hammer unions 22, where torque is applied on a single tab 24 through impact by a hammer, the tool 10 of the present invention may apply torque to the hammer union 22 at two tabs 24. If additional torque is desired, an extension handle (not shown), such as a conventional cheater bar, may be placed over the handle 14 to provide a longer handle and, therefore, increased torque.

The notches 18 in the tool head 12 may be sized slightly larger than the size of the tabs 24. For example, the notches 18 may be ⅛ inch wider and longer than the width and length of the tabs 24. This may permit the tool 10 to be placed on uneven hammer unions 22, such as those previous opened or closed by conventional hammering.

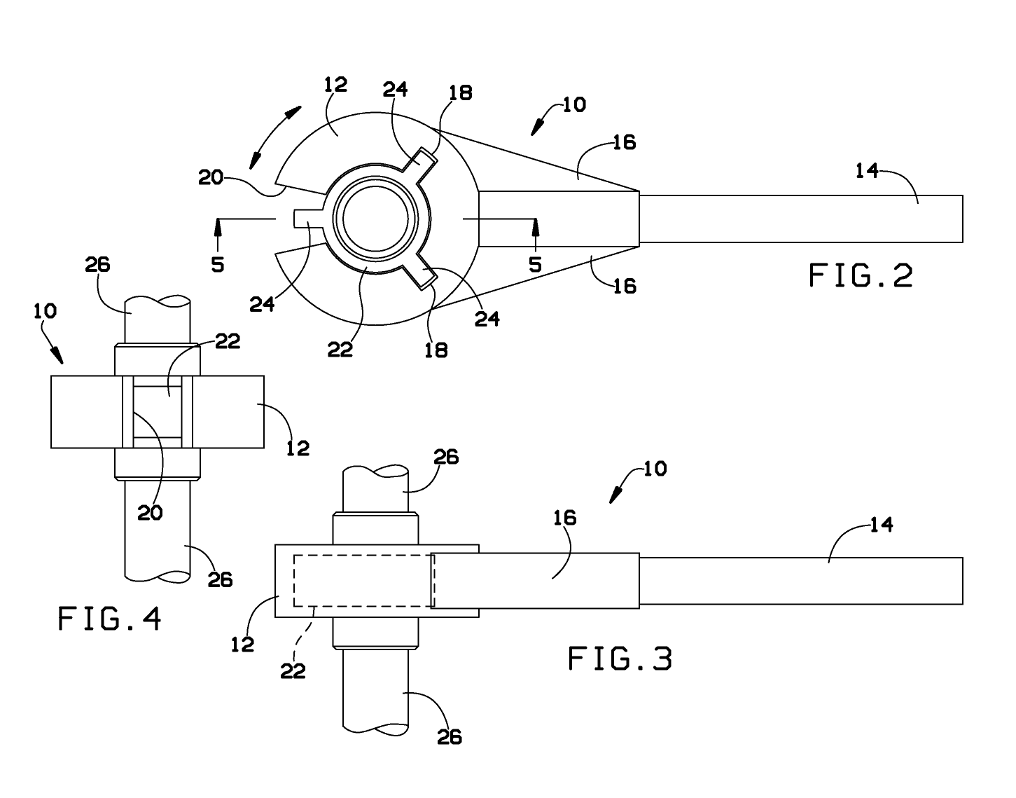

The inside of the tool head 12 may be sized to fit around the hammer union, as shown in FIG. 2. Similar to the notches 18, the inside of the tool head 12 may be sized slightly larger, for example, about ⅛ inch larger, than the hammer union 22, thereby permitting use of the tool 10 on worn or uneven hammer unions. The tool 10 may be sized for use on hammer unions on pipe ranging from about 1 inch to about 6 inches.

The tool 10 may be made of any suitable material, such as hardened steel, cast iron, titanium or the like. In cases where a spark-free environment is necessary, the tool may be made from bronze, aluminum bronze, copper beryllium alloys, and the like. In one embodiment of the present invention, the width of the tool head 12 may be at least twice the size of the width of the hammer union 22. The tool head 12 may include an indication of the direction of applied force by, for example, etching or stamping. This indication may be, for example, an arrow on the tool head 12 indicating the direction to tighten the hammer union 22.

The handle 14 may be positioned on the tool head 12 about 180 degrees from the opening 20. The handle 14 may be attached to the tool head 12 by conventional methods. For example, the handle 14 may be counter sunk or forged in the tool head 12. Bracing or webbing 16 may be added to the outside of the tool head 12 and may attach to the handle 14. The bracing 16 may be disposed on each side of the handle 14 and attached equally to about ½ of the tool head 12. The bracing 16 may extend along the handle 14 for about ⅓ of the overall length of the handle 14. The handle 14 may have a diameter from about ½ inch to about 2 inches, typically about 1 inch. The handle 14 may be at least partially hollow, allowing storage within the handle 14.

The handle 14 may be threadably attached to the tool head 12. This configuration may permit a single handle 14 to be used with a variety of different size tool heads 12. In an alternate embodiment, a first tool head 12 may be positioned on one end of the handle 14 and a second tool head (not shown) may be positioned on the other side of the handle 14, thereby providing two different size tool heads on a single tool.

It should be understood, of course, that the foregoing relates to exemplary embodiments of the invention and that modifications may be made without departing from the spirit and scope of the invention as set forth in the following claims.

What is claimed is:

1. A tool comprising:
a tool head;
a handle attached to and extending from the tool head;
an opening in the tool head adapted to fit a pipe therethrough;
at least one notch an inside surface of the tool head, the notch adapted to fit a tab of a pipe fitting, and the inside surface adapted to fit around at least a portion of the pipe fitting.

2. The tool of claim 1, wherein the plurality of notches are two notches spaced about 120 degrees apart from each other and from the opening.

3. The tool of claim 1, wherein the pipe fitting is a hammer union.

4. The tool of claim 1, further comprising bracing attached to both the handle and the tool head, the bracing adapted to secure the handle and tool head.

5. The tool of claim 1, wherein the at least one notch is sized larger than the size of the tab.

6. The tool of claim 1, wherein the handle is removable attached to the tool head.

7. A tool for opening or closing a hammer union, the tool comprising:
a tool head having an opening, the opening adapted to permit a pipe having the hammer union disposed thereupon to fit into an inside of the tool head;
a handle attached to and extending from the tool head; and
two notches on the inside of the tool head, the notches adapted to align with tabs on the hammer union.

8. The tool of claim 7, wherein the handle is positioned about 180 degrees from the opening on the tool head.

9. A method for opening or closing a hammer union, the method comprising:
positioning a tool such than an inside opening of a tool head is around at least a portion of a pipe;
sliding the tool along the pipe to the hammer union;
positioning two tabs of the hammer union within two notches on the inside opening of the tool head;
applying a force to a handle attached to the tool head, wherein the force applied to the handle applies torque to the hammer union.

10. The method of claim 9, wherein torque is applied to each of the two notches simultaneously.
